(19) United States
(12) Patent Application Publication
(10) Pub. No.: US 2006/0044582 A1
(43) Pub. Date: Mar. 2, 2006

(54) Interface device for coupling image-processing modules

(76) Inventors: Mark D. Seaman, Greeley, CO (US); Larry Chapman, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/928,044

(22) Filed: Aug. 27, 2004

(51) Int. Cl. G06F 3/12

(52) U.S. Cl. 358/1.13; 358/1.15

(57) ABSTRACT

An image-processing system having a processor and image-processing modules configured to process at least one image file, wherein the image-processing modules are independent from one another. Further, an interface device is operatively coupled to the processor and configured to create a process flow to automate at least one sequence of at least two of the plurality of image-processing modules to modify the at least one image file, provide the processor with a standard image format for uniformly using the at least one image file for each of the image-processing modules, and provide the processor with a standard file reference for uniformly accessing the at least one image file for each of the image-processing modules.

### BACKGROUND OF THE RELATED ART

Image capturing technologies employ a variety of approaches to capture information and render this information into a digital form. The information, such as digital photographs or scanned documents, is utilized for business or personal endeavors. An image capturing device, such as a camera or a scanner, captures the desired image information. The captured image information is represented by an image file that may be stored in various hardware-specific and/or application-specific formats.

Regardless of the source of the image information, image files may be processed for a variety of reasons. For example, the image files may be processed to modify the image files, print the image files, or present the image files. To process the image files, one or more different applications or software programs may be utilized. Each of the applications may include different modules to perform specific tasks with the image files. That is, various modules may be utilized to access, modify, and present the images represented by the image files. Accordingly, the different modules may include one or more applications that are utilized to process the image files.

Unfortunately, each of the different applications may be cumbersome and difficult to switch between during processing of the image files. For instance, a user may have to manually start one module in a first application and another module in a second application. As such, the user has to manually start the individual modules and/or applications and manually manage the different modules to process the image files. Accordingly, as more modules are utilized, the manual management of the large numbers of different modules is a difficult and challenging task.

Furthermore, incompatibility between the modules may present additional problems. For instance, the modules associated with the different applications may utilize different protocols, interfaces, and file formats, which are generally incompatible with one another. More specifically, the different applications have different Application Program Interfaces (APIs), which generally include a set of routines, protocols, and tools upon which the different applications are built. As a result, these different applications cannot uniformly communicate inputs and outputs with one another without an application-specific translation, conversion, or manipulation of those inputs and outputs. As a specific example, if a first application has a first image file format, a second application may have to convert or manipulate the first image file format into another format before processing the image files. As a result, the access between the modules of the different applications may be hindered because of incompatible issues.

### BRIEF DESCRIPTION OF THE DRAWINGS

FIG. 1 is a block diagram illustrating the image-processing system in accordance with an exemplary embodiment of the present invention;

FIG. 2 is a block diagram illustrating an exemplary interface device within an image-processing system of FIG. 1 in accordance with an embodiment of the present invention;

FIG. 3 is a block diagram illustrating an exemplary interface device of the image-processing system in FIG. 2 in accordance with embodiments of the present invention;

FIGS. 4-10 are exemplary embodiments of the graphical user interface presented from the interface device through the display of FIG. 3 in accordance with embodiments of the present invention;

FIG. 11 is a flow diagram illustrating the operation of the exemplary image-processing system of FIG. 3 in accordance with embodiments of the present invention; and

FIG. 12 is an exemplary embodiment of the operation of the interface device during the execution of the process flow of FIG. 9 in accordance with embodiments of the present invention.

### DETAILED DESCRIPTION

Embodiments in accordance with the present invention provide an interface device within an image-processing system that provides a standard interface between image-processing modules, which may be associated with one or more applications. The interface device provides a standard image format and standard file reference, which allows independent applications or software modules to exchange image files with each other without file conversions. In one embodiment, the image-processing system may utilize the interface device that executes a user defined process flow, which may combine tasks of multiple image-processing modules together in an automated sequence to modify or access image files. The process flow may include tasks of modules from one or more applications, which may be independent software modules or applications that operate independently of each other. The interface device acts as an intermediate interface to automatically perform multiple functions using multiple products without user interaction. In other words, the image-processing modules in the process flow may utilize the image files without conversions, translations, and other manipulations between different application-specific protocols, file formats, and Application Program Interfaces (APIs).

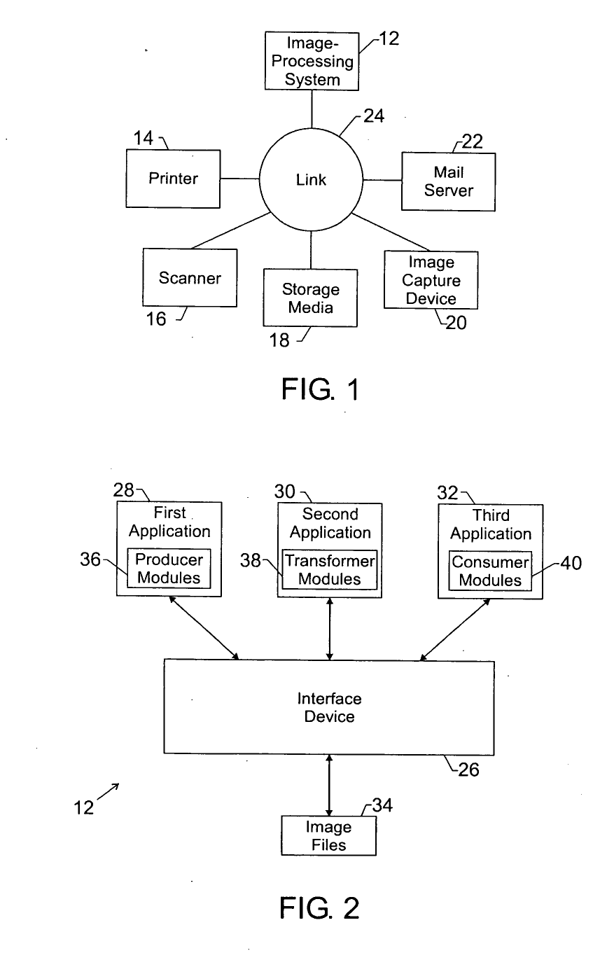

FIG. 1 is a block diagram illustrating an image-processing system 12 in accordance with an exemplary embodiment of the present invention. In this diagram, the image-processing system 12 may be coupled to a printer 14, a scanner 16, a storage media 18, an image capture device 20, and a mail server 22 via a link 24. The image-processing system 12 may interact with these devices 14, 16, 18, 20 and 22 via the link 24 to process one or more image files, which is discussed below in greater detail. It should be appreciated that the devices 14, 16, 18, 20, and 22 are exemplary and that other devices may also be utilized with the image-processing system 12.

The link 24 may include different media to provide connectivity between the image-processing system 12 and the devices 14, 16, 18, 20 and 22. By way of example, the link 24 can provide direct connections, indirect connections (including wireless connections), Internet connections, and/or Intranet connections. For instance, as a network, the link 24 may include a combination of hubs, switches, routers, or the like. The link 24 may be a local area network (“LAN”), a wide area network (“WAN”), or a metropolitan area network (“MAN”), which may assume other forms or may even provide network connectivity through the Internet. Accordingly, the devices 14, 16, 18, 20 and 22 may be dispersed geographically with respect to each other. In another example, as a direct connection, the link 24 may include physical cables, such as fiber connectors or cables, and/or wireless technology to provide a communication path between the image-processing system 12 and the devices 14, 16, 18, 20 and 22.

The link 24 may connect to the printer 14, the scanner 16, the storage media 18, the image capture device 20, and/or the mail server 22. The image-processing system 12 may utilize each of these devices 14, 16, 18, 20 and 22 to produce, store, and/or transfer images files. For instance, the printer 14 may be a device that produces images on a physical media, such as a laser printer, an ink-jet printer, or a dot matrix printer. The scanner 16 may be a device that captures an image file or text and converts it to digital format, such as a bitmapped image. The storage media 18 may be a device that includes memory to store data, such as a server, a desktop computer, a laptop computer, a tablet computer, a personal digital assistant (PDA), or other electronic device. The image capture device 20 may be a device that captures an image and converts it to a digital format, such as a digital still camera, a digital video recorder, or another similar device. The mail server 22 may be a device utilized to transmit data, such as e-mails, between other devices 14, 16, 18 and 20 or systems via the link 24. Accordingly, through the use of the link 24, the image-processing system 12 may utilize each of these devices 14, 16, 18, 20 and 22 for processing of the image files, which is discussed further below in FIG. 2.

FIG. 2 illustrates an exemplary interface device 26 within an image-processing system 12 in accordance with an embodiment of the present invention. In the image-processing system 12, various applications 28, 30 and 32 may utilize the interface device 26 to access one or more image files 34. The applications 28, 30 and 32 may include different modules, such as one or more producer modules 36 to create the images files 34, one or more transformer modules 38 to modify the images files 34, and/or one or more consumer modules 40 to create an output that is not a modification of the image files 34. Each of these modules 36, 38 and 40 may be collectively referenced as image-processing modules. It should be noted that the image-processing system 12 may include a server, a desktop computer, a laptop computer, a tablet computer, a personal digital assistant (PDA), a video card, image capture circuitry, a graphical user interface, a handheld device, or other electronic device. Further, for exemplary purposes, the applications 28, 30 and 32 are shown with one type of image-processing module, but each of the applications 28, 30 and 32 may include one or more of the different module types. As described below, the interface device 26 provides a uniform or standard interface to the image files 34 utilized by the modules 36, 38 and 40.

The interface device 26 may be utilized to define a standard boundary across which applications 28, 30 and 32 or modules 36, 38 and 40 communicate with the image files 34. The interface device 26 provides a standard mechanism, which is platform-independent and/or non-application specific, to provide a standard interaction for the different modules 36, 38 and 40. As used herein, the term “platform-independent” means not dependent on specific software applications or settings and/or specific types of hardware components. The interface device 26 enables tasks from different modules to be chained or linked together in an automated process flow to modify image files 34 without manual management of the applications 28, 30 and 32, modules 36, 38 and 40, or image files 34 by a user. Thus, the interface device 26 enables modules 36, 38 and 40 to be used together without concerns about conversions, translations, and other manipulations between different application-specific protocols, file formats, and/or APIs.

The image files 34 may be digital photographs, scanned documents, images or other data stored within memory. The image files 34 may be stored in a file format, such as Joint Photographic Experts Group (JPEG), Graphics Interchange Format (GIF), Tagged Image File Format (TIFF), Data Exchange File (DXF), Audio Video Interleave (AVI), or other bit-mapped, vector, picture and video graphics file formats. These images files 34 may also be accessed by a standard file reference, such as a Uniform Resource Identifier (URI) or Uniform Resource Locator (URL), which is discussed below.

The applications 28, 30 and 32 maybe software applications or software programs that are utilized to process the image files 34. The applications 28, 30 and 32 may be independently created software programs, such as Microsoft Paint, Visio 2000, MGI PhotoSuite, Adobe Illustrator, or Corel Draw, or other similar applications. Each of these applications 28, 30 and 32 may include one or more modules, such as the producer modules 36, transformer modules 38, and consumer modules 40. For instance, the first application 28 may include a producer module 36; the second application 30 may include a transformer module 38; and the third application 32 may include a consumer module 40.

The modules 36, 38 and 40 may be software programs, firmware programs, hardware components, or a combination of these types. Each of the modules 36, 38 and 40, which may include code stored in memory of the image-processing system 10 or storage media 18, is utilized to process the image files 34 in a specific manner. For instance, the producer module 36 may generate or create the images files 34 that are used as inputs for other image-processing modules. Specifically, the producer module 36 may acquire the image files 34 and store the image files 34 in a specific file location. These input tasks or functions may include creating an array or list of image files 34 or adding image files 34 to an existing list of image files 34. The producer module 36 may include different modules that perform functions, such as opening images, transferring images, retrieving command-lines, opening file lists, unloading a camera/memory card, reading from a disk, downloading from the web, scanning, acquiring images from a camera, and/or other operations.

The transformer module 38 may alter or modify the images files 34. The transformer module 38 may perform tasks, such as a thumbnail selector, red-eye removal, image softening, image sharpening, cropping, color filtering, darkening, black & white conversion, compressing JPEG, lightening, resizing, clearing a photoimage list, removing a non-existent, selecting images, a reviewer, shuffling images, a random photo selector, running a process flow, a process flow runtime chooser, resampling, a simple selector, image compression, a down-sample, auto-correction, editing, and/or other modification operations. These modifications to the image files 34 may replace the existing image files 34 or may be stored in another location to preserve the original image files 34.

Further, the consumer module 40 receives the images files 34 to create an output that is not a modification of the image files 34. That is, the consumer module 40 does not alter the image files 34, but provides a non-transformed image output or a non-image output. For instance, the consumer module 40 may perform tasks, such as album printing, changing format, listing photos, saving file lists, saving files into a directory, FtpGet, image zone, emailing, panorama stitching, a panorama view, printing images, a slide show, a photo album web page, uploading to a directory or web page, uploading to eService, displaying images to a monitor, posting the images to a website, and/or other functions. The consumer module 40 may utilize other devices, such as the printer 102 and/or the mail server 110 of FIG. 1, for example.

The interface device 26 exchanges image files 34 in a flexible and efficient manner. Because the image files 34 have the same format, the interface device 26 provides a standard mechanism for each of the modules 36, 38 and 40 to interact with the image files 34. Thus, the interface device 26 enables image-processing modules to exchange image files 34 without file conversions, translations, and manipulations between different application protocols, APIs, and other application-specific criteria. In other words, two or more different modules can more uniformly access and exchange an image file without the delays or complications of prior conversions or translations of the image file. For example, a producer module 36, such as an “Open File List” module, may obtain a list of image files 34 that may be further processed by a transformer module 38, such as “Black & White” module, to convert the image files 34 into black and white images. Each of the modules may utilize the interface device 26 to exchange the image files 34. Further, the decoupling of the interface device 26 from module-specific input/output criteria enables individuals or third parties to develop different image-processing modules, such as the producer modules 36, transformer modules 38, and consumer modules 40, which are readily recognizable and executable by the image-processing system 12. As such, the interface device 26 enables the image-processing system 12 to utilize, associate, sequence, and cooperatively execute the image-processing modules 36, 38 and 40 that are created by one or more different users or third party application developers. The interface device 26 provides a high degree of flexibility and user interactivity with the image-processing system 12, because the individual modules interact through a standard interface, such as the interface device 26.

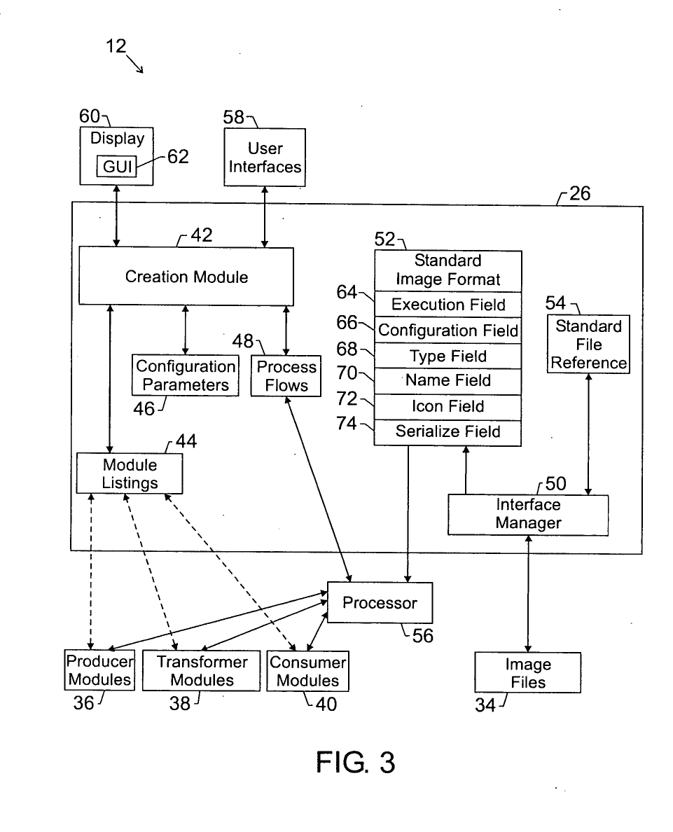

FIG. 3 is a block diagram illustrating an exemplary interface device 26 of the image-processing system 12 in FIG. 2 in accordance with one embodiment of the present invention. In the illustrated embodiment, the interface device 26 within the image-processing system 12 includes various components to create and execute one or more process flows 48. A user may utilize the interface device 26 to select one of the process flows 48 to process the image files 34. To interact with the user, the interface device 26 may communicate with a processor 56, one or more user interfaces 58, and/or a display 60, which enables the user to define and automatically execute the process flow. Accordingly, as discussed below, the image-processing system 12 utilizes the interface device 26 to provide a standard interface between the modules 36, 38 and 40 and the image files 34, regardless of the modules 36, 38 and 40 utilized.

In the image-processing system 12, the processor 56 executes various commands and instructions for the interface device 26 and/or the modules 36, 38 and 40. Accordingly, the processor 56, which may be a single processor or a group of processors, communicates with the various components to facilitate the operation of the producer modules 36, transformer modules 38, consumer modules 40, creation module 42, process flows 48 and interface manager 50. As discussed below in greater detail, the processor 56 loads code associated with the modules 36, 38 and 40 and communicates with the interface device 26 to access the image files 34. Thus, the processor accesses, loads, and executes the code associated with various modules in the image-processing system 12.

To interact with a user, the interface device 26 may utilize the one or more user interfaces 58 and the display 60. The user interfaces 58 may include a keyboard, a numeric keypad, a light pen, a mouse, a joystick, a digitizer pad, a biometric reader, a microphone, a video camera, and/or other user interaction devices. The display 60 may include a liquid-crystal display (LCD), a cathode-ray tube (CRT), light emitting diodes (LEDs), and/or other monitoring or display devices. The display 60 may also present a graphical user interface (GUI) 62 that is provided to assist in the interaction with the user. The GUI 62 may include virtual buttons and text boxes, which are described in more detail below.

The user interacts with the GUI 62 associated with the creation module 42 to create and/or select a process flow by utilizing the user interfaces 58 and display 60. The creation module 42 may be a software program executed by the processor 56 to enable the user to create, select, edit, and generally organize the modules 36, 38 and 40 into one or more process flows 48. The processor 56 may provide the GUI 62 to the display 60 to present information about the modules 36, 38 and 40 and/or the image files 34 to the user. Accordingly, the user may interact with the creation module 42 through the GUI 62 by utilizing the user interfaces 58, which may be a keyboard and/or mouse, for example. As a result, the user may link or chain modules 36, 38 and 40 together to process the image files 34 in a user defined process flow or sequence, as discussed below.

To create the process flows 48, the creation module 42 may receive inputs from module listings 44 and/or configuration parameters 46. The module listings 44 are one or more lists of tasks available in the image-processing modules, such as the producer modules 36, transformer modules 38 and consumer modules 40. The module listings 44 may be stored in a variety of formats, such as a text file, an extensible markup language (XML) file, a hypertext markup language (HTML) file, a spreadsheet, a database, or a word processing file, which is accessible by the creation module 42. The module listings 44 also may include a local or remote path, such as uniform resource locator (URL), a network path, or a directory path, to the various modules 36, 38 and 40. Similarly, the configuration parameters 46 may be default settings or options that are configurable by the user for each of the modules 36, 38 and 40. For instance, the configuration parameters may adjust the gray scale settings of a module that converts a color image into a black and white image. Each of these inputs may be utilized to modify or create a specific process flow.

The process flows 48 may be a list of functions or tasks to be performed by one or more of the image-processing modules to process the image files 34. The process flows 48 may include one or more user defined task lists that indicate the different functions of various modules to be utilized for processing the image files 34 and a specific order to execute the modules and specific tasks or actions in each module. This order may specify that functions of different modules 36, 38 and 40 are to be executed in a specific sequence, such as serially, in parallel, or a combination of both. The process flows 48 may be stored in memory, as predefined process flows or may be created by the user via the creation module 42. For instance, a process flow may be previously created to include the open image file module, red-eye removal module, and print image file module, which may be stored as a specific process flow. This process flow, which may include modules from different applications, may be created and stored for access by the user.

Once the user has selected or created one of the process flows 48, it is provided to the processor 56 for execution. To execute a specific one of the process flows 48, the processor 56 may utilize the interface manager 50 to access and to provide the image files 34 in a standard manner for each of the modules 36, 38 and 40. Accordingly, the interface manager 50 facilitates the modification of the image files 34 by providing a standard image format 52 and standard file reference 54 to the processor 56. The standard file reference 54 identifies storage and/or access locations for each of the image files 34 or a subset of the image files 34. The standard file reference 54 may include a location indicia or identifier, such as a location or address on a computer, server, network, scanner, still camera, video camera, printer, plotter, robotic painting device, and/or monitor. The standard file reference 54 may include a Uniform Resource Identifier (URI), such as a Uniform Resource Locator (URL). Further, the interface manager 50 utilizes the standard image format 52 to facilitate the modification of the image files 34 by the modules 36, 38 and 40, which are executed by the processor 56. The standard image format 52 may include various fields that include information about the image files 34 and the image-processing modules, which is further discussed below. Accordingly, the interface manager 50, through the use of the standard file reference 54 and the standard image format 52, provides access to the image files 34 in a standard manner for each of the modules 36, 38 and 40.

The standard image format 52 may include various information fields for the image-processing modules or the image files 34. These information fields provide a standard or uniform interface (e.g., non-application specific and non-hardware specific) between the modules 36, 38 and 40 of each of the process flows 60 being executed by the processor 56. For example, the standard image format 52 may include an execution field 64, configuration field 66, type field 68, name field 70, icon field 72, and/or a serialize field 74. The execution field 64 may include the standard file references 54 associated with the image files 34. The configuration field 66 may include various option settings and operational parameters that are defined for the modules 36, 38 and 40. The type field 68 may indicate the specific type of the module, which may be one of the producer modules 36, transformer modules 38 or consumer modules 40. A name field 70 may relate to the specific name of the modules 36, 38 and 40 being utilized. The icon field 72 and the serialize field 74 may also be used to store various information that is utilized by the processor 56 to execute the modules 36, 38 and 40.

Beneficially, by utilizing the interface device 26 with the standard image format 52 and standard file reference 54, the interaction of the modules 36, 38 and 40 in the process flows 48 may be executed without the complexities and incompatibilities associated with multiple different hardware specific and software specific criteria. Thus, the process flows 48 may be performed automatically without the manual selection by a user of different applications. This reduces the problems associated with input/output formats and communication protocols incompatibilities. Accordingly, the interface device 26 enables the user to define process flows 48 that enable different modules 36, 38 and 40 to process and exchange the image file without converting the image file to a format, which is specific to the module processing the image file. Further, this standardization or unification also enables developers, such as third party hardware and software manufacturers, to provide additional functionality to the image-processing system 12. This provides greater flexibility and modularity between different platforms and sources of these functional modules. In this manner, the image-processing system 12 is a modular system of plug-and-play modules that can be selectively paired together to form an integrated image-processing sequence or process flow.

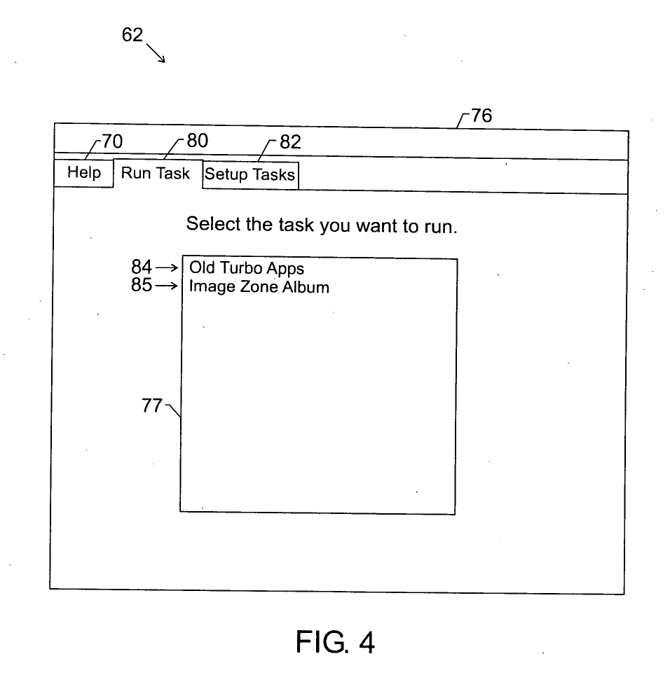

For interaction with the user, the creation module 42 may present the user with different virtual pages via the display 60, which are part of a GUI 62. These virtual pages may enable interaction between the user and the creation module 42 being executed by the processor 56 to create and execute one of the process flows 48. The creation and execution of an exemplary process flow, which may be one of the process flows 48, is further described below in FIGS. 4-10. In these FIGS. 4-10, the virtual pages may include a “Help” page (not shown) that provides assistance to the user, a “Run Task” page 76 that executes the process flows 48, and a “Setup Tasks” page 86 for configuring the process flows 48 or providing information about the process flows. The interface device 12 may utilize each of these pages 76 and 86 to provide the user with virtual access to the creation module 42, module listings 44, configuration parameters 46, process flows 48, the interface manager 50, the standard image format 52, and standard file references 54. An exemplary embodiment of the GUI 62 that interacts with the user is further described below in FIGS. 4-10. However, it should be noted that these FIGS. 4-10 are merely utilized for exemplary purposes and may include any of the various modules 36, 38 and 40 discussed above or even a variety of combinations of the modules 36, 38 and 40.

FIG. 4 is an exemplary embodiment of the “Run Task” page 76 that is part of the GUI 62 presented from the interface device 26 to the user through the display 60 of FIG. 3. As shown in FIG. 4, the “Run Task” page 76 may include a “Help” button 78 to access the “Help” page, a “Run Task” button 80 to access the “Run Task” page 76, and a “Setup Tasks” button 82 to access the “Setup Tasks” page 86. The “Run Task” page 76 provides the user with a selection of different process flows 48 that may be stored within the interface device 26 or within the image-processing system 12.

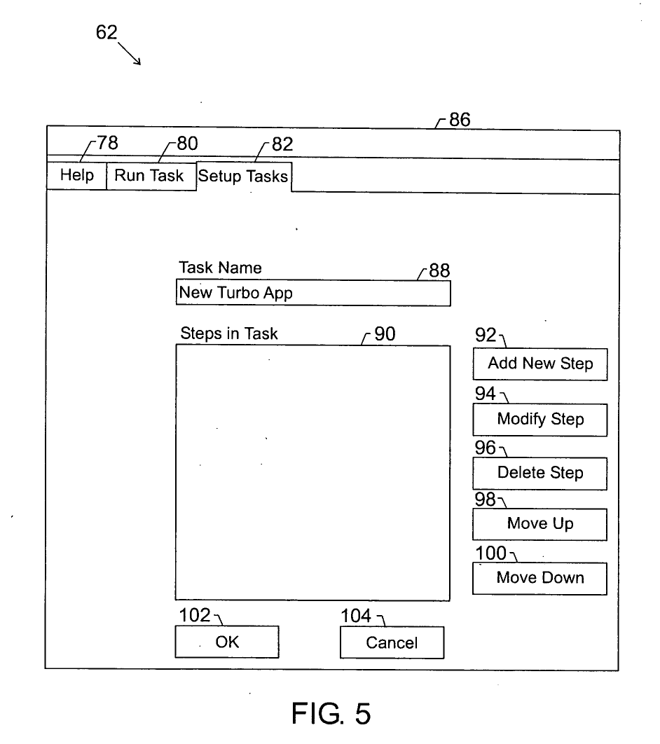

In the “Run Task” page 76, a text box 77 may be utilized to present the process flows 48 for the user. For instance, the text box 77 may include entries 84 and 85 that represent different process flows 48. The “Old Turbo App” entry 84 and the “Image Zone Album” entry 85 may each represent one of the process flows 48. As noted above, these process flows 48 may include one or more of the image-processing modules, such as producer modules 36, transformer modules 38, consumer modules 40. To execute one of the process flows 48, the user may select one of the entries 84 and 85 or may create a new process flow. By selecting one of the entries 84 and 85, the associated process flow may be performed. However, to create a new process flow, the user may select the “Setup Tasks” button 82, which is discussed in FIG. 5.

FIG. 5 is an exemplary embodiment of the “Setup Tasks” page 86 that is part of the GUI 62 presented from the interface device 26 to the user through the display 60 of FIG. 3. As shown in FIG. 5, the “Setup Tasks” page 86 of the GUI 62 may include text boxes 88 and 90 and virtual buttons 92, 94, 96, 98, 100, 102 and 104 for defining process flows 48 using tasks in one or more of the modules 36, 38 and 40. Accordingly, from a user's standpoint, the “Setup Tasks” page 86 provides the user with the ability to create a process flow from the modules 36, 38 and 40 that are available for use by the interface device 26.

In the “Setup Tasks” page 86, the text boxes 88 and 90 and virtual buttons 92, 94, 96, 98, 100, 102 and 104 are utilized to define a process flow, such as the “New Turbo App” process flow, which may be one of the process flows 48 of FIG. 3. The name of the process flow, which is “New Turbo App” in this example, is located in the “Task Name” box 88. The user may utilize the user interfaces 58 of FIG. 3 to change or enter this textual information into the “Task Name” box 88. In the “Steps in Task” box 90, the modules 36, 38 and 40 utilized in this process flow may be represented.

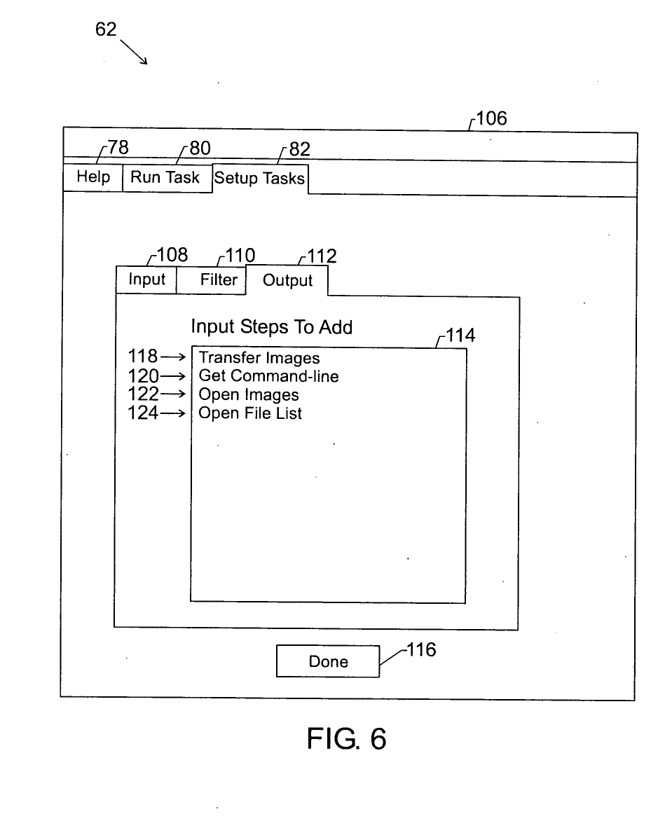

To create a process flow, the buttons 92, 94, 96, 98, 100, 102 and 104 may be utilized to add, delete, and modify the tasks utilized in the process flow. For instance, the virtual buttons may include an “Add New Step” button 92, “Modify Step” button 94, “Delete Step” button 96, “Move Up” button 98, “Move Down” button 100, “OK” button 102, and “Cancel” button 104. Specifically, the user may include one of the modules 36, 38 and 40 with the “Add New Step” button 92, modify the settings of a module 36, 38 and 40 with the “Modify Step” button 94, and remove one of the modules 36, 38 and 40 with the “Delete Step” button 96. Similarly, the user may rearrange the modules 36,38 and 40 with the “Move Up” button 98 and the “Move Down” button 100, respectively. Once the user has defined the tasks in the proper order, the user may accept the process flow with the “OK” button 102 or may cancel the process flow with the “Cancel” button 104. To add, delete, and modify the tasks utilized in the process flow, the user may select the buttons, which present additional pages to the user, as discussed in FIGS. 6-9.

FIG. 6 is an exemplary embodiment of the “Input Steps to Add” page 106 that is part of the GLUI 62 presented from the interface device 26 to the user through the display 60 of FIG. 3. To add a task to the process flow, the user may select the “Add New Step” button 92 of FIG. 5, which results in the user being presented the “Input Steps to Add” page 106. As shown in FIG. 6, the “Input Steps to Add” page 106 may include a text box 114 and virtual buttons 108, 110, 112 and 116 for accessing different tasks in the process flow. Accordingly, from a user's standpoint, the “Input Steps to Add” page 106 provides the user with the ability to select or add a task from the different tasks that represent the modules 36, 38 and 40.

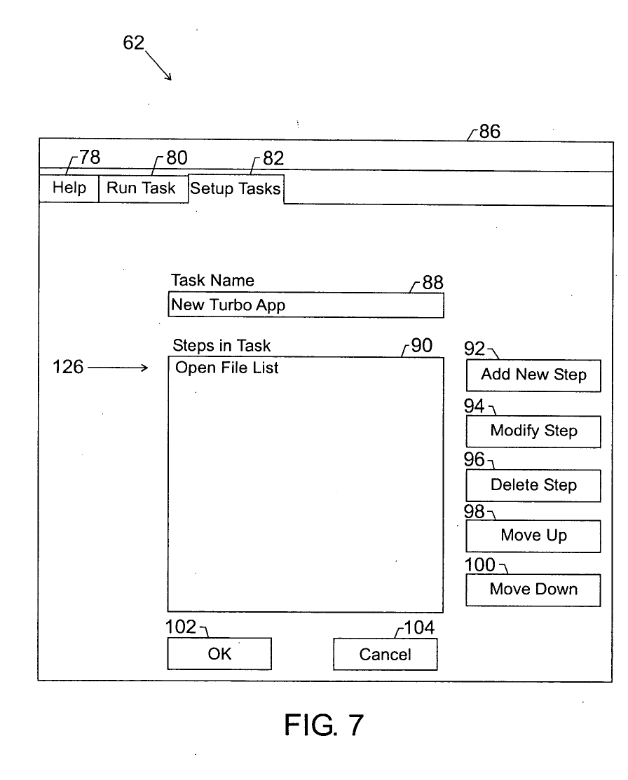

In the “Input Steps to Add” page 106, the text box 114 and virtual buttons 108, 110, 112 and 116 are utilized to add a task to the process flow being created. The buttons 108, 110 and 112 may provide access to lists of tasks associated with the different modules 36, 38 and 40. For instance, the “Input” button 108 may provide a list of tasks that are associated with the producer modules 36, the “Filter” button 110 may provide a list of tasks that are associated with the transformer modules 38, and the “Output” button 112 may provide a list of tasks that are associated with the consumer modules 40. Each list of the tasks may be presented in the text box 114 as individual entries 118, 120, 122 and 124. For instance, the “Transfer Images” entry 118 may access image files 34 from one location and move the image files 34 to a second location. The “Get Command-line” entry 120 may access a command line for a string that indicates a location and obtain the image files 34 at that location. Further, the “Open Images” entry 122 may access the image files 34 and open the image files 34, while the “Open File List” entry 124 may access a list of image files 34 and open the image files 34 in the associated list. Accordingly, the user may select one of the entries 118, 120, 122 and 124 to select a specific task. Then, the user may accept the selected task with the “Done” button 114 or may select another task by pressing one of the buttons 108, 110 and 112 or selecting another entry 118, 120, 122 or 124. The selection of one of the tasks from the “Input Steps to Add” page 106 is discussed below in FIG. 7.

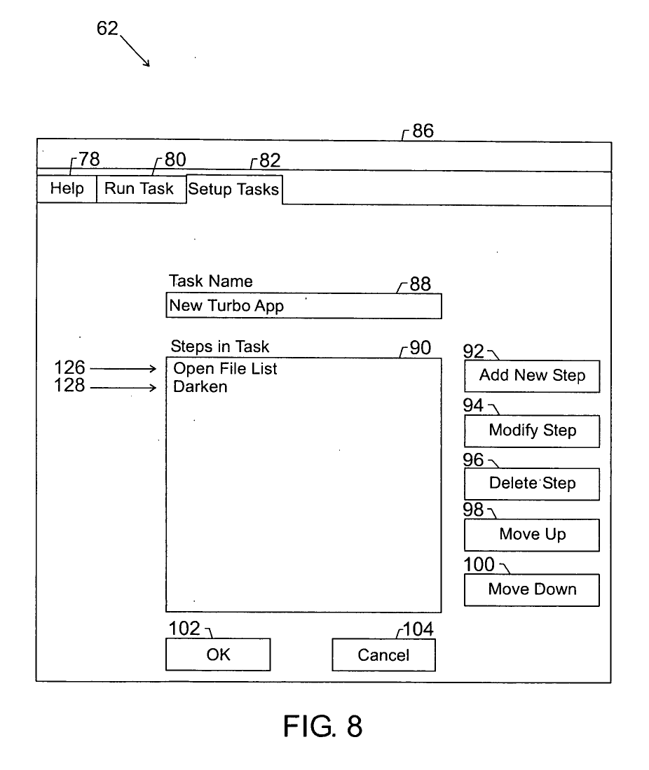

FIG. 7 is a second exemplary embodiment of the “Setup Tasks” page 86 that is part of the GUI 62 presented from the interface device 26 to the user through the display 60 of FIG. 3. As discussed above in FIG. 5, the “Setup Tasks” page 86 may include text boxes 88 and 90 and virtual buttons 92, 94, 96, 98, 100, 102 and 104. As shown in FIG. 7, the “Steps in Task” box 90 may include an “Open File List” entry 126, which may access a list of image files 34 and open the image files 34 in the associated list. Thus, the “Open File List” entry 126 has been added to the “New Turbo App” process flow. Accordingly, other tasks may be selected from the “Input Steps to Add” page 106 in a manner similar to the discussion of FIG. 6. The addition of a second task is discussed below in FIG. 8.

FIG. 8 is a third exemplary embodiment of the “Setup Tasks” page 86 that is part of the GUI 62 presented from the interface device 26 to the user through the display 60 of FIG. 3. As discussed above in FIG. 7, the “Setup Tasks” page 86 of the GUI 62 may include text boxes 88 and 90 and virtual buttons 92, 94, 96, 98, 100, 102 and 104. In FIG. 8, the “Steps in Task” box 90 may include a second task that is represented by the “Darken” entry 128, which may adjust the contrast of image files 34. The “Darken” entry 128 may be added to the process flow by utilizing the “Add New Step” button 92, as discussed above in FIG. 6. As such, the “Darken” entry 128 has been added to the “New Turbo App” process flow.

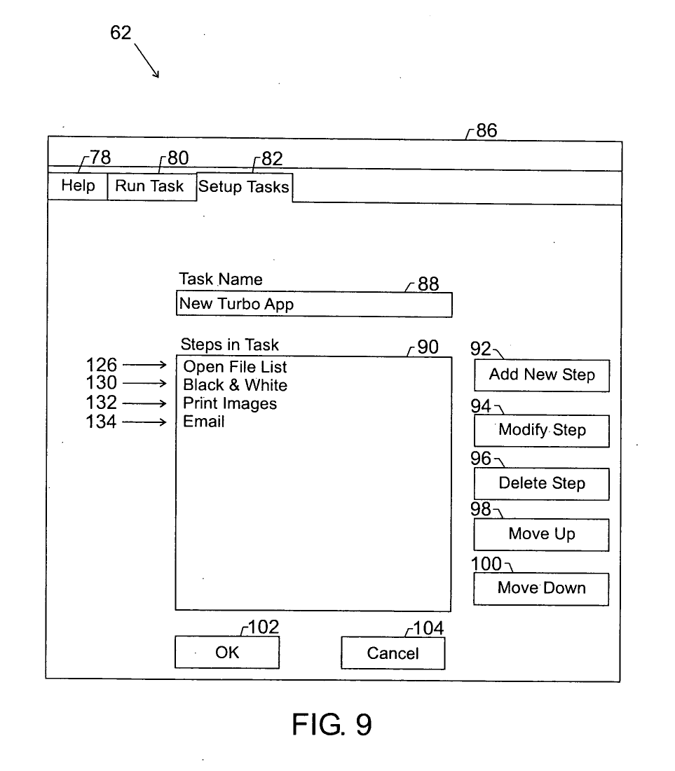

Further, the tasks in the “New Turbo App” process flow may be deleted from the process flow. As an example, the user may select the “Darken” entry 128. Then, the user may utilize the “Delete Step” button 96 to remove the task represented by the “Darken” entry 128 from the process flow. The deletion of a task from the process flow results in the process flow described above in FIG. 7. Accordingly, other tasks may be added, deleted and modified to form a process flow in a similar manner, as described in FIG. 9.

FIG. 9 is a fourth exemplary embodiment of the “Setup Tasks” page 86 that is part of the GUI 62 presented from the interface device 26 to the user through the display 60 of FIG. 3. As discussed above, the “Setup Tasks” page 86 of the GUI 62 may include text boxes 88 and 90 and virtual buttons 92, 94, 96, 98, 100, 102 and 104. As shown in FIG. 9, the “Steps in Task” box 90 may include a list of tasks that are associated with the “New Turbo App” process flow.

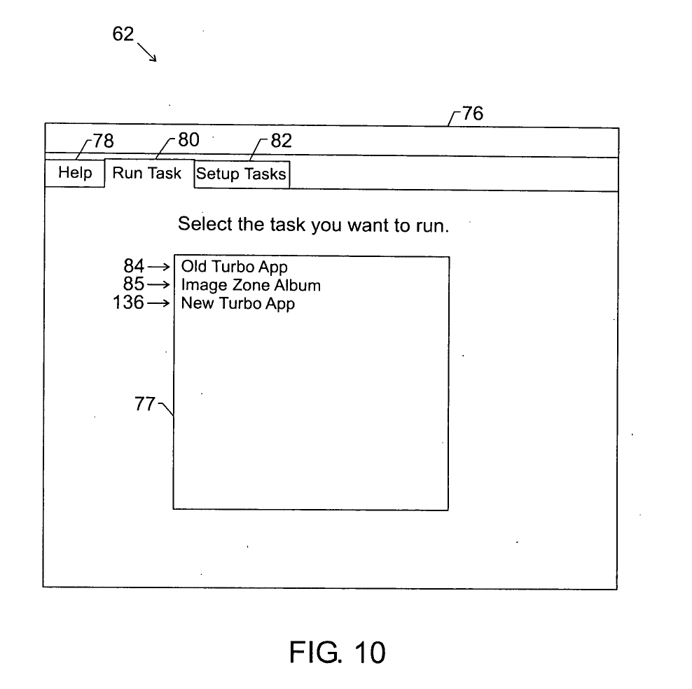

Within the process flow, different tasks may be utilized with each other that are associated with the different modules 36, 38 and 40. Each of these tasks may be represented by the entries 126, 130, 132 and 134. For instance, the “Open File List” entry 126 represents a task in one of the producer modules 36, which may access a list of image files 34 and open the image files 34 in the associated list. The “Black & White” entry 130 represents a task in one of the transformer modules 38, which may convert color images into black and white images. Further, the “Print Images” entry 132 represents a task in one of the consumer modules 40, which may print the image on a printer, such as the printer 14 (FIG. 1). Also, the “Email” entry 134 represents a task in one of the consumer modules 40, which may send the image files 34 to a server, such as the mail server 22 (FIG. 1). Once the user has defined the tasks in the proper order, the user may accept the process flow with the “OK” button 102 to execute the process flow, as described in FIG. 10.

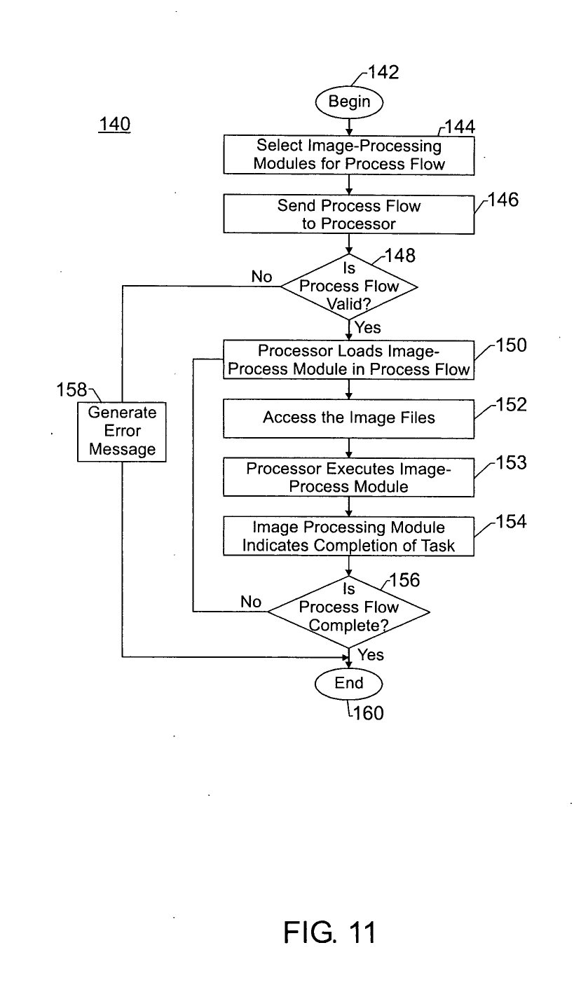

FIG. 10 is a second exemplary embodiment of the “Run Task” page 76 that is part of the GUI 62 presented from the interface device 26 to the user through the display 60 of FIG. 3. As discussed above, the “Run Task” page 76 of the GUI 62 may include buttons 78, 80 and 82 along with the text box 77 that presents the process flows 48 to the user. In addition to the entries 84 and 85, the text box 77 may include a “New Turbo App” entry 136, which is the “New Turbo App” process flow described in FIG. 9. The user may selection one of the different entries 84, 85 and 136, as discussed above, to execute the process flow. The operation of an exemplary process flow in the image-processing system 12 is described in FIG. 11 below.

The operation of a process flow in the image-processing system 12 of FIG. 3 is shown in FIG. 11. In the illustrated diagram 140, the interface device 26 may be utilized by the processor that is executing one of the process flows 48 of FIG. 3. Accordingly, the diagram 140 may be best understood by concurrently referring to FIG. 3. The process flow may include producer modules 36, transformer modules 38, and consumer modules 40, which may be collectively referenced as the image-processing modules. Accordingly, by utilizing the interface device 26, the image-processing modules of a process flow may be executed automatically in a non-application specific and non-hardware specific manner.

The execution of the process flow begins at block 142. A process flow, which is one of the process flows 48, is created by a user and provided to the processor 56 in blocks 144-148. At block 144, the user selects image-processing modules to be included in the process flow. The user may also use a user-defined process flow or a previously created process flow. The process flow may define a sequence for the image-processing modules within the process flow. At block 146, the process flow is sent to the processor 56 to process the image files 34 according to the sequence within the process flow. The processor 56 verifies that the image-processing modules in the process flow are valid at block 148. The validation of the image-processing modules may be performed when the image-processing system 12 is booted-up or when the interface device 26 is initialized. For instance, if the interface device utilizes an auto-discovery routine, it may verify the image-processing modules available interface device 26. If one or more of the image-processing modules are invalid, then the processor 56 does not perform the process flow and generates an error message that is presented to the user, as shown in block 158. However, if the image-processing modules are valid, then the processor 56 executes each of the image-processing modules in the process flow, as shown in blocks 150-156.

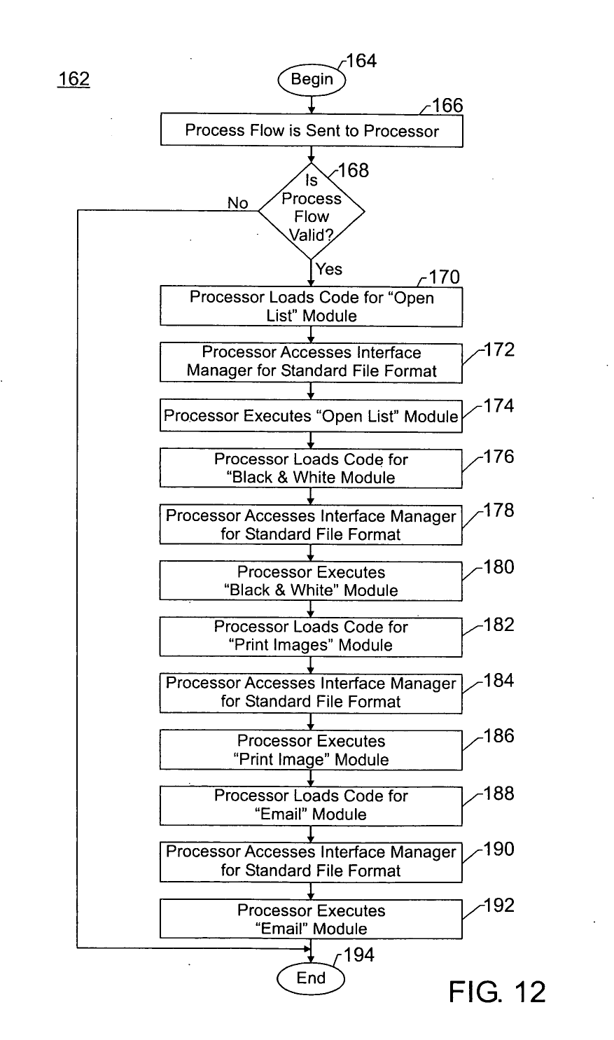

In blocks 150-156, the processor 56 executes each of the image-processing modules according to the sequence that is defined within the process flow. To begin, the processor loads the first image-processing module listed in the process flow, as shown in block 150. Then, the processor 56 accesses the image files 34 through the interface device 26, as shown in block 152. The accessing block 152 may provide a standard image format 52 to the processor 56 for execution of the associated image-processing module and image files 34. Depending on the particular embodiment, the image-processing module may perform its operations on the standard file reference 54 or image files 34. Then, the processor executes the image-processing module, as shown in block 153. Upon completion of the modules operations, the image-processing module at block 154 may provide an output or completion indicator, which triggers a query block 156. The output may include providing the list of image files 34 to another module or storing the image files 34 in memory. Further, the image-processing module may return image files 34 or standard file reference 54 that are modified to the interface device 26. At query block 156, the processor 56 determines whether another image-processing module is to be utilized from the process flow. If more image-processing modules are to be utilized, then the processor 56 may execute the next image-processing module, as shown in block 150. However, if no other image-processing modules are to be utilized, then the process may end at block 160. As a specific example, the operation of the “New Turbo App” process flow is describes in FIG. 12 below.

FIG. 12 is an exemplary embodiment of the operation of the interface device 26 during the execution of the process flow described in FIGS. 9 and 10 in accordance with embodiments of the present invention. In this flow diagram 162, which may be best understood by concurrently referring to FIG. 3, the processor 56 may execute the process flow to process the image files 34 in the specific manner listed in the defined process flow. The interface device 26 may provide a standard image format 52 and standard file reference 54 for the image files 34 that are being accessed by the processor 56 executing the modules 36, 38 and 40.

The process begins at block 164. At block 166, the “New Turbo App” process flow may be sent to the processor 56. The “New Turbo App” process flow may be sent by the user selecting the process flow from a list of available process flows 48, presented on the “Run Task” page 76. In this example, the “New Turbo App” process flow is provided to the processor 56 for execution. The “New Turbo App” process flow is an XML list that includes the entries, which represent the tasks performed by the “Open File List” module, “Black & White” module, “Print Images” module, and the “Email” module, respectively.

Then, the processor 56 verifies the “New Turbo App” process flow in block 168. At block 168, the processor 56 may verify that the image-processing modules are valid. The validation may include verifying that the code associated with the image-processing modules indicated in the process flow is present on the system, which may be completed at initialization of the image-processing system 12 or before the execution of the process flow. If the process flow is not valid, the process may end at block 194. However, if the process flow is valid, then the processor 56 may access the interface manager 50 to begin the process flow.

To perform the process flow, the processor 56 executes the “Open File List” module, which is associated with the “Open File List” entry 126 of the “New Turbo App” process flow, as shown in blocks 170-174. At block 170, the processor 56 loads the code associated with the “Open File List” module. Then, the processor 56 accesses the interface manager 50 for the standard image format 52 and standard file reference 54 associated with the image files 34, as shown in block 172. The interface manager 50 may utilize the standard file reference 54 to determine the location of the image files 34 and access the image files 34 to create the standard image format 52. Once the standard image format 52 and standard file reference 54 are received, the processor 56 then executes the “Open File List” module, as shown in block 174.

After the “Open File List” module has executed, the processor 56 executes the “Black & White” module, which is associated with the “Black & White” entry 130 of the “New Turbo App” process flow, as shown in blocks 176-180. At block 176, the processor 56 loads the code associated with the “Black & White” module. Then, the processor 56 accesses the interface manager 50 for the standard image format 52 and standard file reference 54 associated with the image files 34, as shown in block 178. Again, the interface manager 50 may utilize the standard file reference 54 to determine the location of the image files 34 and access the image files 34 to create the standard image format 52. The image files 34 may be stored in the memory in communication with or coupled to the processor 56, the interface device 26, or in another location specified by the standard file reference 54. At block 180, the processor 56 then executes the “Black & White” module.

Then, the processor 56 executes the “Print Images” module, which is associated with the “Print Images” entry 132 of the “New Turbo App” process flow, as shown in blocks 182-186. The processor 56 loads the code associated with the “Print Images” module, as shown in block 182. At block 184, the processor 56 accesses the interface manager 50 for the standard image format 52 and standard file reference 54 associated with the image files 34. Again, the interface manager 50 may utilize the standard file reference 54 to determine the location of the image files 34 and access the image files 34 to create the standard image format 52. The processor 56 then executes the “Print Images” module, as shown in block 186.

Finally, once the “Print Images” module has executed, the processor 56 executes the “Email” module, which is associated with the “Email” entry 80 of the “New Turbo. App” process flow, as shown in blocks 188-192. The processor 56 loads the code associated with the “Email” module, as shown in block 188. Then, the processor 56 accesses the interface manager 50 for the standard image format 52 and standard file reference 54 associated with the image files 34, as shown in block 190. Again, the interface manager 50 may utilize the standard file reference 54 to determine the location of the image files 34 and access the image files 34 to create the standard image format 52. At block 192, the processor 56 executes the “Email” module. The execution of the “Email” module may include storing the image files 34 in the location referenced by the standard file reference 54. Accordingly, the process ends at block 194.

Alternatively, it should be appreciated that the process flow may include the parallel execution of the various tasks of the modules 36, 38 and 40. The parallel execution of tasks may be performed in the process flow that is provided to two or more processors. For instance, if the image-processing system 10 includes two or more processors 56, then the tasks associated with the “Print Images” module and the “Email” module may be executed substantially concurrently. This parallel execution of the “Print Images” module and the “Email” module may be performed, if a first processor loads the code for the “Print Images” module, as shown in block 182, and a second processor loads the code for the “Email” module, as shown in block 188. Then, each of the processors may access the interface device 26 for the respective module and execute the respective modules, as shown in blocks 184, 186, 190 and 192. Once the modules have completed the specific task, the process may end at block 194. Thus, the process flow may include parallel, serial, or a combination of different sequences.

What is claimed is:

1. An image-processing system, comprising:
a processor;
a plurality of image-processing modules coupled to the processor and configured to be utilized by the processor to process at least one image file, wherein the plurality of image-processing modules are independent from one another; and
an interface device coupled to the processor and configured to:
create a process flow to automate at least one sequence of at least two of the plurality of image-processing modules to modify the at least one image file;
provide the processor with a standard image format for uniformly obtaining the at least one image file for each of the plurality of image-processing modules; and
provide-the processor with a standard file reference for uniformly accessing the at least one image file for each of the plurality of image-processing modules.

2. The image-processing system set forth in claim 1, wherein a first of the plurality of image-processing modules is associated with a first application and a second of the plurality of image-processing modules is associated with a second application, wherein the first and second applications operate independent of each other and have different functions from each other.

3. The image-processing system set forth in claim 1, comprising a creation module adapted to interact with a user to select and order at least two of the plurality of image-processing modules to create the process flow that is automatically executed by the processor.

4. The image-processing system set forth in claim 1, wherein the at least one sequence comprises a parallel operation of at least two of the plurality of image-processing modules that are executed at the same time.

5. The image-processing system set forth in claim 1, wherein the plurality of image-processing modules comprises a producer module that accesses the at least one image file to create a list of at least one image file.

6. The image-processing system set forth in claim 1, wherein the standard image format comprises at least one image field associated with the at least one image file and at least one module field associated with the type of each of the plurality of image-processing modules.

7. The image-processing system set forth in claim 1, wherein the process flow comprises an extensible markup language (XML) file that lists the at least one sequence of the plurality of image-processing modules in the process flow.

8. A method of processing at least one image file, comprising:
providing a process flow comprising a sequence of a plurality of image-processing modules having a first image-processing module and a second image-processing module that are independent from one another;
accessing the at least one image by the first image-processing module via an interface device comprising a standard image format and a standard file reference; and
modifying the at least one image by the second image-processing module, wherein the interface device communicatively interfaces the first and second image-processing modules in the sequence of the process flow to exchange the at least one image file without the plurality of image-processing modules having to perform an application-specific translation or conversion of the at least one image file.

9. The method set forth in claim 8, comprising executing each of the plurality of image-processing modules in the sequence of the process flow on a processor to process at least one image file.

10. The method set forth in claim 8, wherein one of the plurality of image-processing modules is associated with a first application and another of the plurality of image-processing modules is associated with a second application, wherein the first and second applications are independent from one another and perform different functions on the at least one image file.

11. The method set forth in claim 8, wherein the standard image format comprises a plurality of fields associated with at least one of the plurality of the image-processing modules and at least one image file.

12. The method as set forth in claim 8, wherein providing the process flow comprises interactively selecting at least one of the plurality of image-processing modules from at least one module listing and interactively ordering the plurality of image-processing modules in the sequence.

13. The method as set forth in claim 8, comprising executing each of the plurality of image-processing modules in parallel on a plurality of processors to process at least one image file.

14. A system for image-processing, comprising:
means for providing a process flow comprising at least one sequence of a plurality of image-processing modules, wherein the image-processing modules are independent from one another;
means for communicatively interfacing the plurality of image-processing modules in the process flow via a standard image format and a standard file reference; and
means for automatically executing the plurality of image-processing modules in the at least one sequence of the process flow to process an image file, wherein one of the plurality of image-processing modules is associated with a first application and another of the plurality of image-processing modules is associated with a second application, wherein the first and second applications are independent from one another and perform different functions on the image file.

15. A system, comprising:
at least one processor;
a first image-processing module in a first application configured to interact with the at least one processor and process a plurality of image files;
a second image-processing module in a second application configured to interact with the at least one processor and process the plurality of image files; and
an interface device operatively coupled to the at least one processor and configured to:
create a process flow to automate at least one sequence of the first and second image-processing modules to modify the plurality of image files;
provide a standard image format for uniformly obtaining the at least one image file for each of the first and second image-processing modules; and
provide a standard file reference for uniformly accessing the plurality of image files for each of the first and second image-processing modules.

16. The system set forth in claim 15, wherein the process flow comprises an extensible markup language (XML) file that lists the first and second image-processing modules in the order defined by the at least one sequence in the process flow.

17. The system set forth in claim 15, wherein at least one processor executes the first image-processing module and the second image-processing module in a serial order.

18. The system set forth in claim 15, wherein at least one processor comprises a first processor and a second processor, the first processor executes the first image-processing module and the second processor executes the second image-processing module in parallel.

19. The system set forth in claim 15, wherein the standard image format comprises a plurality of fields associated with the at least one image file and one of the plurality of the image-processing modules.

20. A computer readable medium, comprising:
interface device code adapted to interface a plurality of image-processing modules of at least two different applications via a standard image format and a standard file reference, wherein the image-processing modules are independent from one another; and
process flow code adapted to organize the plurality of image-processing modules in a sequence, wherein the process flow is adapted to automate the sequence of at least two of the plurality of image-processing modules, wherein the process flow code automatically executes the sequence and utilize the interface device code to interact between the plurality of image-processing modules in the sequence, and wherein at least two of the plurality of image-processing modules in the sequence are executed in parallel.
